(19) United States
(12) Patent Application Publication
(10) Pub. No.: US 2024/0231838 A1
(43) Pub. Date: Jul. 11, 2024

(54) METHODS FOR GENERATING CONFIGURATION DATA PACKET AND FILE, PROCESSING METHOD, DEVICE AND MEDIUM

(71) Applicant: BOE TECHNOLOGY GROUP CO., LTD., Beijing (CN)

(72) Inventor: Yingjie LI, Beijing (CN)

(21) Appl. No.: 17/789,713

(22) PCT Filed: May 31, 2021
(86) PCT No.: PCT/CN2021/097353

§ 371 Date: Dec. 8, 2022

(51) Int. Cl. G06F 9/445

(52) U.S. Cl. CPC G06F 9/445

(57) ABSTRACT

The present disclosure provides a method for generating a configuration data packet of an application, including steps of: executing an instruction for generating preliminary data, and generating the configuration data packet according to the generated preliminary data. The step of generating the preliminary data includes: determining, in response to a function add instruction, initial data of a target function corresponding to the function add instruction; and performing parameter configuration on the initial data to obtain preliminary data. For any function add instruction, the preliminary data is one of local preliminary data and cloud preliminary data. The present disclosure further provides a method for generating an application file, a method for processing request information, an electronic device, and a computer-readable storage medium.

### TECHNICAL FIELD

The present disclosure relates to the field of computer technology, and specifically relates to a method for generating a configuration data packet of an application, a method for generating an application file, a method for processing request information, an electronic device, and a computer-readable storage medium.

### BACKGROUND

With the development of the information industry, there is an increasing demand for enterprises and individuals to build applications (or software) to solve various problems.

The traditional software development mode involves higher requirements on professional skills of developers, longer development period and higher cost. To address this problem, low-code development platforms have emerged in recent years.

### SUMMARY

An object of the present disclosure is to provide a method for generating a configuration data packet of an application, a method for generating an application file, a method for processing request information, an electronic device, and a computer-readable storage medium.

The method for generating a configuration data packet of an application includes steps of: executing an instruction for generating preliminary data N times, and generating the configuration data packet according to the generated preliminary data, wherein N is a positive integer, and N≥1, and each time of executing the instruction for generating preliminary data includes: determining, in response to a function add instruction, initial data of a target function corresponding to the function add instruction; and performing parameter configuration on the initial data to obtain the preliminary data. For any function add instruction, the preliminary data is one of local preliminary data and cloud preliminary data, the local preliminary data is obtained by performing parameter configuration on initial data of a local component capable of implementing the target function corresponding to the function add instruction, and the cloud preliminary data is obtained by performing parameter configuration on related information of a cloud component capable of implementing the target function corresponding to the function add instruction.

Optionally, in a case that N>1, the application includes a flow having A nodes respectively corresponding to A target functions, and 1<A<N, the step of generating the configuration data packet according to the generated preliminary data includes:
generating flow data from preliminary data for implementing the A target functions; and
generating the configuration data packet from the flow data and (N-A) sets of preliminary data corresponding to target functions not included in the flow;
in a case that N>1, the application includes a flow having A nodes respectively corresponding to A target functions, and A=N, the step of generating the configuration data packet according to the generated preliminary data includes:
generating flow data from A sets of preliminary data for implementing A target functions; and
generating the configuration data packet from the flow data.

Optionally, generating flow data from A sets of preliminary data for implementing A target functions includes:
determining an i^{th} set of preliminary data in response to an i^{th} node add instruction, and processing the i^{th} set of preliminary data to obtain node data of an i^{th} node, wherein the i^{th} set of preliminary data includes preliminary data corresponding to a target function corresponding to the i^{th} node add instruction, where i is a positive integer, and takes a value from 1 to (A−1) in sequence;
determining a (i+1)^{th} set of preliminary data in response to a (i+1)^{th} node add instruction, and processing the (i+1)^{th} set of preliminary data to obtain node data of a (i+1)^{th} node, wherein the (i+1)^{th} set of preliminary data includes preliminary data corresponding to a target function corresponding to the (i+1)^{th} node add instruction, and a trigger expression of the (i+1)^{th} node;
processing the node data of the i^{th} node by using index information of the node data of the (i+1)^{th} node, so that the node data of the I^{th} node carries index information of the (i+1)^{th} set of preliminary data; and
generating the flow data from the first (A−1) sets of preliminary data each carrying index information and a trigger expression, and the A^{th} set of preliminary data not carrying index information.

Optionally, the flow includes at least one pair of interrelated nodes, initial data corresponding to interrelated nodes in a same pair includes initial associated data, and for the interrelated nodes in the same pair, processing the preliminary data corresponding to a node later in sequence in the flow to obtain node data of the node includes:
converting final associated data in a node earlier in sequence in the flow to obtain associated configuration parameters; and
configuring initial associated data in the preliminary data of the node later in sequence in the flow by using the associated configuration parameters.

Optionally, each time of generating the preliminary data further includes, before determining, in response to the function add instruction, initial data of the target function corresponding to the function add instruction:
determining, according to a start position of a second selection instruction on an operation interface, a type icon corresponding to the target function, and generating a function add instruction corresponding to the type icon, wherein there is a correspondence relationship between the type icon and the initial data.

Optionally, each time of generating the preliminary data further includes, before determining, in response to the function add instruction, initial data of the target function corresponding to the function add instruction, and after determining, according to the start position of the second selection instruction on the operation interface, the type icon corresponding to the target function, and generating the function add instruction corresponding to the type icon:
controlling a display panel to display a parameter configuration interface associated with the target function; and
the step of determining, for any function add instruction, initial data of the target function corresponding to the function add instruction includes:
taking initial data corresponding to the type icon as the initial data corresponding to the function add instruction, wherein configuration parameters corresponding to the target function are received through the parameter configuration interface.

Optionally, for at least one function add instruction, each time of generating the preliminary data further includes, before determining, according to the start position of the second selection instruction on the operation interface, the type icon corresponding to the target function, and generating the function add instruction corresponding to the type icon:
determining, according to a start position of a first selection instruction on the operation interface, a control icon corresponding to the target function; and
controlling, when a position of the first selection instruction on the operation interface is ended in a preset region, a display panel to display a control icon selected by the first selection instruction in the preset region; and
binding received display information with the control icon selected by the first selection instruction, so that the display information is displayed when the control icon is clicked; and
the method further includes after determining, according to the start position of the second selection instruction on the operation interface, the type icon corresponding to the target function, and generating the function add instruction corresponding to the type icon:
establishing an association relationship between the control icon and the target function.

Optionally, when the initial data is of event type, performing parameter configuration on the initial data of event type includes:
receiving event configuration parameters input from outside, wherein the event configuration parameters include an event name and at least one of: an attribute key value of the initial data, an attribute expression of the initial data, trigger mode information and associated control information; and
acquiring preliminary data of the initial data of event type according to the event configuration parameters.

Optionally, when the initial data is of cloud interface type, performing parameter configuration on the initial data of cloud interface type includes:
receiving at least one of a URL, a path, request mode information, a URL parameter, a header parameter and a body parameter input from outside; and
when the initial data is of local interface type, performing parameter configuration on the initial data of local interface type includes:
receiving information about a local service and a calling mode of the local service input from outside, wherein the information about the calling mode is any one of synchronous calling or asynchronous calling.

Optionally, when the initial data is of cloud interface type or local interface type, after acquiring the preliminary data, the method further includes:
testing a service corresponding to the initial data.

Optionally, the step of generating the configuration data packet according to the generated preliminary data includes:
deleting, in response to a function delete instruction, preliminary data corresponding to the function delete instruction from the N sets of preliminary data; and
generating the configuration data packet from the remaining preliminary data.

Optionally, the method further includes, after generating the configuration data packet according to N sets of preliminary data:
parsing and running the configuration data packet in response to a preview instruction.

Optionally, the method further includes:
storing the configuration data locally.

Optionally, the method further includes:
sending the configuration data to a server side.

As a second aspect of the present disclosure, there is provided a method for generating an application file, including:
receiving a configuration data packet generated by the method according to the first aspect of the present disclosure; and
parsing and compiling the configuration data packet to generate the application file.

As a third aspect of the present disclosure, there is provided a method for processing request information, including:
parsing, in response to received request information, the request information to determine preliminary data corresponding to the request information, wherein the preliminary data is one of local preliminary data and cloud preliminary data, the local preliminary data is obtained by performing parameter configuration on initial data of a local component capable of implementing a target function corresponding to a function add instruction, and the cloud preliminary data is obtained by performing parameter configuration on cloud information capable of implementing a target function corresponding to the function add instruction;
parsing the preliminary data to determine a component corresponding to the preliminary data;
running, in a case that the component corresponding to the preliminary data includes a local component, the local component; and
acquiring, in a case that the component corresponding to the preliminary data includes a cloud component, data returned from the cloud component through an interface.

As a fourth aspect of the present disclosure, there is provided an electronic device, including:
one or more processors; and
a storage device having stored thereon an executable program which, when executed by the one or more processors, causes the one or more processors to carry out any one of the above three methods.

As a fifth aspect of the present disclosure, there is provided a computer-readable storage medium having a computer program stored thereon which, when executed by a processor, causes the processor to carry out any one of the above three methods.

### BRIEF DESCRIPTION OF DRAWINGS

Accompanying drawings are provided for a further understanding of this disclosure and constitute a part of the specification. Hereinafter, these drawings are intended to explain the disclosure together with the following specific implementations, but should not be considered as a limitation to the present disclosure. In the drawings:

FIG. 1 is a flowchart of an implementation of a method for generating a configuration data packet of an application according to the present disclosure;

FIG. 2 is a flowchart of an implementation of a step of generating preliminary data;

FIG. 3 is a flowchart of an implementation of a step of generating a configuration data packet based on the generated preliminary data when 1<A<N;

FIG. 4 is a flowchart of an implementation of the step of generating a configuration data packet based on the generated preliminary data when A=N;

FIG. 5 is a flowchart of an implementation of a step of generating flow data from A sets of preliminary data for implementing A target functions;

FIG. 6 is a flowchart of another implementation of a method for generating a configuration data packet of an application according to the present disclosure;

FIG. 7 is a schematic diagram of a graphical interface on a terminal;

FIG. 8 is a flowchart of an implementation of a method for installing an application according to the present disclosure; and

FIG. 9 is a flowchart of an implementation of a method for processing request information according to the present disclosure.

### DETAIL DESCRIPTION OF EMBODIMENTS

Hereinafter, specific implementations of the present disclosure will be described with respect to the accompanying drawings. It will be appreciated that the specific implementations as set forth herein are merely for the purpose of illustration and explanation of the present disclosure and should not be constructed as a limitation thereof.

As an aspect of the present disclosure, there is provided a method for generating a configuration data packet of an application. As shown in FIG. 1, the method includes executing an instruction for generating preliminary data N times, and generating the configuration data packet according to the generated preliminary data, where N is a positive integer, and N≥1.

In the present disclosure, for ease of description, each time of “executing an instruction for generating preliminary data” is indicated by “step S100”. In the present disclosure, N is the number of times of executing step S100. Similarly, for ease of description, the step of “generating the configuration data packet according to the generated preliminary data” is indicated by “step S200”.

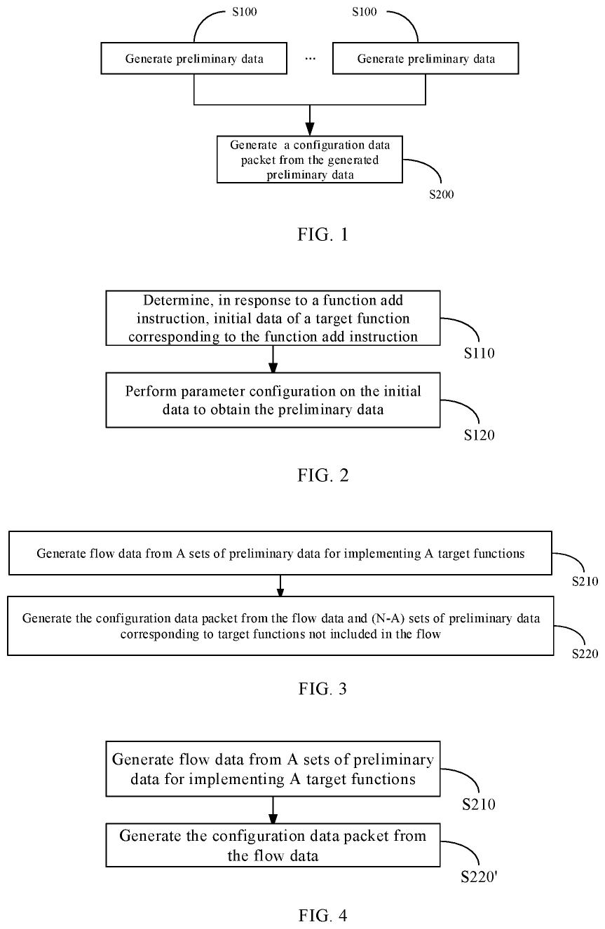

As shown in FIG. 2, each time of executing the instruction for generating preliminary data includes the following steps S110 to S120.

At step S110, in response to a function add instruction, initial data of a target function corresponding to the function add instruction is determined.

At step S120, parameter configuration is performed on the initial data to obtain the preliminary data.

In the present disclosure, for any function add instruction, the preliminary data is one of local preliminary data and cloud preliminary data, the local preliminary data is obtained by performing parameter configuration on initial data of a local component capable of implementing the target function corresponding to the function add instruction, and the cloud preliminary data is obtained by performing parameter configuration on cloud information capable of implementing the target function corresponding to the function add instruction.

In the present disclosure, the “initial data” refers to data for implementing a target function but not subjected to parameter configuration. For example, a certain plug-in for broadcasting weather is downloaded on an electronic device, and after being configured by a user in terms of “place”, “date”, “personal preference setting”, and the like, the plug-in can broadcast the weather of the “place” according to the date and personal preference configured by the user. The data of the plug-in before the configuration by the user is the “initial data” of the plug-in.

In the present disclosure, the “related information” of the cloud component is not particularly limited. As an optional implementation, a cloud server stores a cloud component capable of implementing a target function, the cloud information includes interface information of the cloud component, and access to the cloud component can be implemented by configuring the interface information.

As another optional implementation, in a case that the cloud server does not store any cloud component capable of implementing a target function, a retrieval may be performed according to the target function to obtain a cloud retrieve data packet corresponding to the target function, and the cloud server returns the cloud retrieve data packet to the local electronic device, which converts the data to obtain the “initial data”, and then parameter configuration is further performed on the initial data to obtain the preliminary data. This process is equivalent to performing parameter configuration on the “cloud information” to obtain the preliminary data.

The method according to in the present disclosure corresponds to a low-code platform, and after the configuration data packet is generated by the method of the present disclosure, the configuration data packet is compiled to obtain an installation file of the application.

As an optional implementation, the electronic device executing the method has a plurality of components capable of implementing a plurality of functions pre-stored therein, each component has corresponding initial data. That is, the electronic device stores therein a plurality of sets of initial data.

When the target function corresponding to the function add instruction can be implemented by a locally stored component, the data corresponding to the local component is used as the initial data corresponding to the function add instruction. When the target function corresponding to the function add instruction cannot be implemented by any locally stored component, a request for a cloud component capable of implementing the function is sent to the server, and data corresponding to the cloud component is used as the initial data corresponding to the function add instruction.

As described above, when the server does not store any component capable of implementing the above function, the server may perform a retrieval according to the function add instruction to obtain a cloud retrieve data packet.

The function add instruction is input by a user through an input module, and in the present disclosure, the specific type of the function add instruction is not particularly limited. For example, the function add instruction may be in text form, and the target function and the initial data corresponding to the target function may be determined according to the text content. For another example, the function add instruction may be an operation point input by a user through touch or a mouse, and the target function and the initial data corresponding to the target function may be determined according to a position of the operation point.

In the present disclosure, local and cloud components may be called to obtain a configuration data packet of an application file having the target function. Moreover, when generating a configuration data packet of an application file by the method of the present disclosure, it is only necessary to clarify the target function to be implemented and a logic relationship among various target functions, but there is no need to master any programming technology. Therefore, with the method of the present disclosure, an application range of the application development work is expanded, and the development efficiency is improved.

As an optional implementation, the application includes a flow having A nodes, where A is a positive integer, and 1<A≤N, and A nodes correspond to A target functions, respectively.

When 1<A<N, as shown in FIG. 3, step S200 may include the following steps S210 to S220.

At step S210, flow data is generated from A sets of preliminary data for implementing A target functions.

At step S220, the configuration data packet is generated from the flow data and (N-A) sets of preliminary data corresponding to target functions not included in the flow.

That is, in this implementation, the configuration data packet may include flow data corresponding to the flow, and preliminary data independent of the flow. In other words, in this implementation, the application obtained after installing the configuration data packet can implement N target functions in total. Among the N target functions, (N-A) target functions are independent of each other, and A target functions correspond to A functions in a same flow (i.e., the A functions may be implemented sequentially after the flow is triggered).

When A=N, as shown in FIG. 4, step S200 may include the following steps S210 to S220′.

At step S210, flow data is generated from A sets of preliminary data for implementing A target functions.

At step S220′, the configuration data packet is generated from the flow data.

In this implementation, the configuration data packet includes only the flow data corresponding to the flow.

Since the configuration data packet includes the flow data, the installation file generated from the flow data in the configuration data packet also relates to the flow, so that the flow can be implemented when running the application.

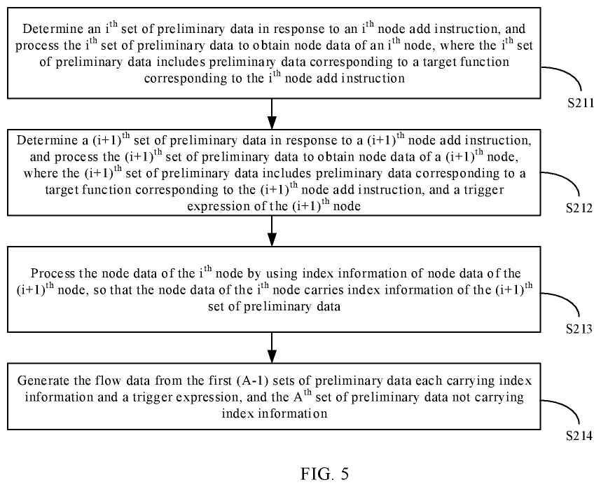

In the present disclosure, how to generate the flow data is not particularly limited as long as the flow data can reflect respective nodes of the corresponding flow and a sequence thereof. As an optional implementation, as shown in FIG. 5, step S210 of generating flow data from A sets of preliminary data for implementing A target functions may include the following steps S211 to S214.

At step S211, an i^{th} set of preliminary data is determined in response to an i^{th} node add instruction, and the i^{th} set of preliminary data is processed to obtain node data of an i^{th} node, where the i^{th} set of preliminary data includes preliminary data corresponding to a target function corresponding to the i^{th} node add instruction, where i is a positive integer, and takes a value from 1 to A−1 in sequence.

At step S212, a (i+1)^{th} set of preliminary data is determined in response to a (i+1)^{th} node add instruction, and the (i+1)^{th} set of preliminary data is processed to obtain node data of a (i+1)^{th} node, where the (i+1)^{th} set of preliminary data includes preliminary data corresponding to a target function corresponding to the (i+1)^{th} node add instruction, and a trigger expression of the (i+1)^{th} node.

At step S213, the node data of the i^{th} node is processed by using index information of the node data of the (i+1)^{th} node, so that the node data of the i^{th} node carries index information of the (i+1)^{th} set of preliminary data.

At step S214, the flow data is generated from the first (A−1) sets of preliminary data each carrying index information and a trigger expression and the A^{th} set of preliminary data not carrying index information.

In the present disclosure, steps S212 and S213 are executed cyclically until a termination condition of i=A−1 is met.

Since the node data of a current node carries the index information of node data of a next node, when the flow is executed and after the execution at the i^{th} node is completed, the next node to be executed can be determined according to the index information carried in the i^{th} node, and when the trigger expression is met, execution at the next node is automatically performed.

In the present disclosure, the trigger expression is not particularly limited. For example, the trigger expression may be a judgment expression (true), or may be other logical operations. For example, it may be a logical operation like “2 >1”, where the left side of the inequation indicates the number of execution times of a certain operation in the application, the right side of the inequation indicates a set number of times, and the trigger expression “2 >1” indicates that the flow will be triggered when a certain operation is executed 1 or more times.

In the present disclosure, configuration parameters of different nodes in a same flow may be interrelated or not. Some flows include at least one pair of interrelated nodes, initial data corresponding to interrelated nodes in a same pair includes initial associated data, and for the interrelated nodes in the same pair, the step of processing the preliminary data corresponding to a node later in sequence in the flow to obtain node data of the node includes:
converting final associated data in a node earlier in sequence in the flow to obtain an associated configuration parameter; and
configuring initial associated data in preliminary data of the node later in sequence in the flow by using the associated configuration parameter.

For example, the flow of “obtaining weather of city a” includes the following nodes: clicking a button to display “city a”→acquiring weather of “city a”→displaying weather of city a.

In the above flow, the first node is of event type, and the second node is of interface type. The node data of the first node includes initial data corresponding to “place name”, and the second node also includes initial data corresponding to “place name”. After the initial data about “place name” in the first node is configured as “city a”, “city a” may be taken as a configuration parameter to configure the initial data about “place name” in the second node.

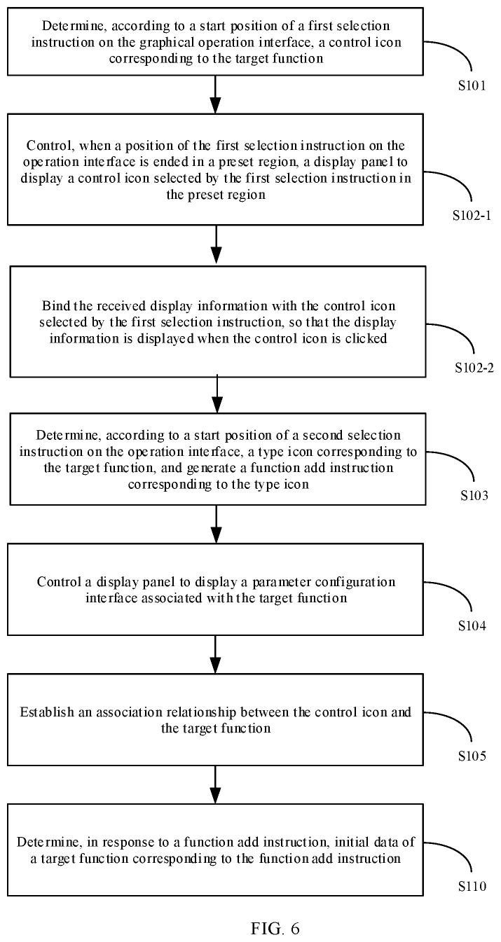

As described above, the method is applied to an electronic device implementing a low-code platform, and it should be noted that the electronic device has a display panel through which a graphical operation interface can be displayed. The graphical operation interface may display a type icon (event type, interface type or the like) of a function, and the preset region of the graphical operation interface is an edit region. The graphical operation interface can further facilitate man-machine interaction. Accordingly, as shown in FIG. 6, each time of generating the preliminary data may further include step S103 before step S110.

At step S103, a type icon corresponding to the target function is determined according to a start position of a second selection instruction on an operation interface, and a function add instruction corresponding to the type icon is generated, where there is a correspondence relationship between the type icon and the initial data.

In the present disclosure, a mapping relationship between type icons and initial data corresponding to the respective target functions is configured in advance. When a type icon is selected, it means that the corresponding initial function data is selected.

In order to facilitate parameter configuration of the initial data corresponding to the type icon, optionally, as shown in FIG. 6, each time of generating the preliminary data may further include step S104 between step S103 and step S110.

At step S104, a display panel is controlled to display a parameter configuration interface associated with the target function.

Accordingly, the step of determining initial data of the target function corresponding to the function add instruction includes: taking the initial data corresponding to the type icon as the initial data corresponding to the function add instruction. Configuration parameters corresponding to the target function may be received through the parameter configuration interface.

In order to facilitate operation, the graphical operation interface is further provided with a control icon (a button icon, a text box icon, or the like), and by operating the control icon, a subsequent associated action can be triggered. For example, after being dragged into the edit region, the control icon may be associated with an event, and the associated event can be triggered through the control icon in the edit region.

Accordingly, for at least one function add instruction, as shown in FIG. 6, each time of generating the preliminary data may further include steps S101, S102-1 and S102-2 before step S103.

At step S101, a control icon corresponding to the target function is determined, according to a start position of a first selection instruction on the graphical operation interface.

At step S102-1, when a position of the first selection instruction on the operation interface is ended in a preset region, a display panel is controlled to display a control icon selected by the first selection instruction in the preset region.

At step S102-2, the received display information is bonded with the control icon selected by the first selection instruction, so that the display information is displayed when the control icon is clicked.

Each time of generating the preliminary data may further include step S105 after step S103.

At step S105, an association relationship between the control icon and the target function is established.

Through the above steps S101 to S105, a user may drag the control icon to the preset region (i.e., the edit region) by dragging the control icon, and establish an association relationship between the control icon and the target function by selecting the type icon. At step S103, after the association relationship between the control icon and the target function is established, the target function can be implemented by operating the control icon.

It should be noted that the “display information” mentioned in the present disclosure may be display information input by a user through an input module. As an optional implementation, the display information may be stored in a provider.

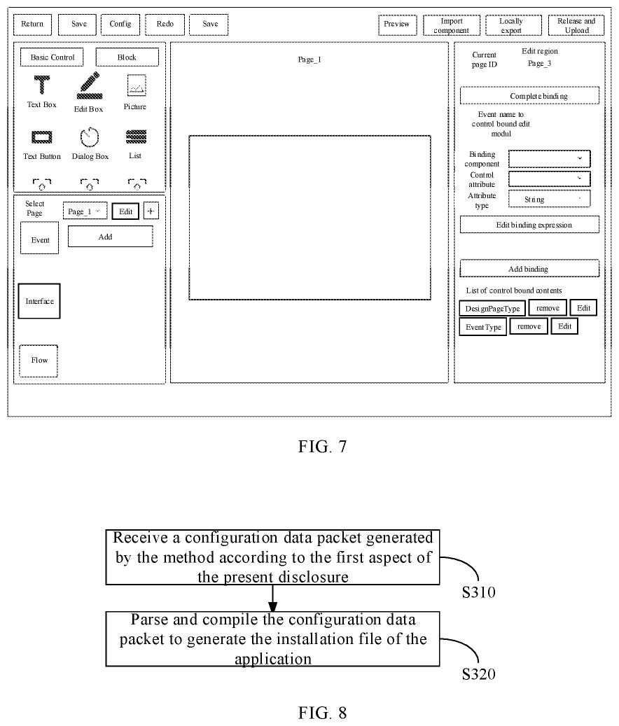

FIG. 7 shows a schematic diagram of an operation interface. A plurality of control icons (for example, including a text box icon, an edit box icon, a picture icon, a text box button icon, a dialog box icon, a list icon, and the like) are displayed in region I, a plurality of type icons (for example, including an event icon, an interface icon, a flow icon, and the like) are displayed in region II, region III is the preset region (i.e., the edit region), and the parameter configuration interface is displayed in region IV.

In the present disclosure, how to generate the first selection instruction and the second selection instruction is not particularly limited. As an optional implementation, the first selection instruction and the second selection instruction may be selection instructions input through any one of a mouse, a keyboard, and a touch screen.

In the present disclosure, the position of the “parameter configuration interface” is not particularly limited. For example, the parameter configuration interface may be in the vicinity of the control icon, and when the control icon is “dragged” into the preset region, the parameter configuration interface corresponding to the control icon is displayed. In the implementation shown in FIG. 7, the parameter configuration interface is displayed at a periphery of the preset region.

After the user inputs the configuration parameters through the parameter configuration interface, the corresponding preliminary data can be generated from the configuration parameters.

The specific content of the configuration parameters is related to the type of initial data (i.e., the component that implements the target function). When the initial data is of event type, configuration parameters of the initial data of event type include an event name and at least one of: an attribute key value of the initial data, an attribute expression of the initial data, trigger mode information and associated control information.

Accordingly, performing parameter configuration on the initial data of event type includes:
receiving event configuration parameters input from outside, where the event configuration parameters include an event name and at least one of: an attribute key value (i.e., key value) of the initial data, an attribute expression of the initial data, trigger mode information and associated control information; and
acquiring preliminary data of the initial data of event type according to the event configuration parameters.

In the present disclosure, a user may configure the attribute key value, the value expression, the trigger mode information, and the like for the initial data of event type (hereinafter, referred to as “event”), so as to associate an icon (which may be a control) on the operation interface with a corresponding event. For example, by configuring the attribute key value, the value expression, the trigger information, and the like, a button may be associated with an event, and the event may be triggered by clicking the button. In the present disclosure, one icon may be associated with a plurality of events, and parameter configuration may be performed for each event.

In the present disclosure, after the initial data is configured with an attribute expression, corresponding parameters may be obtained according to the attribute expression after an event corresponding to the initial data is triggered. In the present disclosure, the attribute expression may be expressed in a programming language such as javascript or the like, while expression of a data container, a UI control (equivalent to an icon), an event value, or the like may be supported by specific characters.

When the initial data is of interface type, there are two situations: one is that the initial data is of cloud interface type, and the other is that the initial data is of local interface type.

When the initial data is of cloud interface type, performing parameter configuration on the initial data of cloud interface type includes:
receiving at least one of a URL, a path, request mode information, a URL parameter, a header parameter and a body parameter input from outside.

When the initial data is of local interface type, performing parameter configuration on the initial data of local interface type includes:
receiving information about a local service and a calling mode of the local service input from outside, where the information about the calling mode is any one of synchronous calling or asynchronous calling.

As an optional implementation, in the case that the initial data is of cloud interface type or local interface type, after acquiring the preliminary data, the method further includes:
testing a service corresponding to the initial data.

As an optional implementation, the method further includes after generating the configuration data packet according to N sets of preliminary data:
parsing and running the configuration data packet in response to a preview instruction.

In the present disclosure, the configuration data packet is for generating an installation file of an application. The configuration data packet may be compiled locally to generate the installation file, and accordingly, the method further includes: storing the configuration data packet locally.

In the present disclosure, the local storage mode and storage type of the configuration data packet are not particularly limited. Typically, the corresponding configuration data packet may be named while being stored. Further editing of the locally stored configuration data packet may be performed subsequently.

For example, in the implementation shown in FIG. 7, the configuration data packet is stored in the form of “page,” or may be named in the form of page. In the specific implementation shown in FIG. 7, the configuration data packet may be named as “Page_1”. For ease of operation, a drop-down list may be provided on the graphical operation interface, and configuration data packet that is stored in the body and available for selection is provided in the drop-down list.

The configuration data packet may also be sent to a server side, so that the configuration data packet is compiled at the server side to generate the installation file. Accordingly, the method further includes: sending the configuration data packet to a server side.

In the present disclosure, how to perform step S130 is not particularly limited. As an optional implementation, the configuration data packet may be formed directly from N sets of preliminary data.

In order to improve flexibility of the method, optionally, after N sets of preliminary data are obtained, if the user wants to reduce the number of target functions, the corresponding preliminary data may be deleted. In this implementation, step S130 may include:
deleting, in response to a function delete instruction, preliminary data corresponding to the function delete instruction from the N sets of preliminary data; and
generating the configuration data packet from the remaining preliminary data.

The method according to the present disclosure is described below in several specific embodiments in conjunction with the graphical operation interface shown in FIG. 7.

Firstly, the graphical operation interface shown in FIG. 7 will be briefly described. As shown in the figure, the graphical operation interface mainly includes four regions: region I in which a plurality of control icons (for example, including a text box icon, an edit box icon, a picture icon, a text box button icon, a dialog box icon, a list icon, and the like) are displayed, region II in which a plurality of type icons (for example, including an event icon, an interface icon, a flow icon, and the like) are displayed, region III which is the preset region (i.e., the edit region), and region IV in which the parameter configuration interface is displayed.

In FIG. 7, the configuration data packet is in the form of “page”. Therefore, adding the preliminary data for implementing a target function to the configuration data packet is equivalent to binding the preliminary data to the page. Therefore, the content displayed on the parameter configuration interface includes “current page ID”, “complete binding”, “binding component”, “control attribute”, “attribute type”, and the like which can be easily understood by a user.

The “complete binding” refers to a button that the user independently selects to click after addition of the preliminary data desired to be added is completed.

The “edit binding expression” refers to establishing a mapping relationship between a control icon and preliminary data according to content input by the user.

The “add binding” refers to placing the current page in an editable state to enable addition of new preliminary data to the current page.

Embodiment 1, establishing a configuration data packet including preliminary data of event type, that is, N=1 in step S110.

The event is named as event1, the event type is data source (i.e., display text), an attribute key value param of the event is text, and accordingly, the attribute expression is @{WIDGET(button1.text)}. Button button1 needs to be clicked in order to trigger event1.

For the user, the following operations need to be performed:
selecting control icon “text box button” in the graphical operation interface (i.e., generating a first selection instruction), and dragging the text box button to an edit region for function preview;
inputting a text field to be displayed (e.g., city a) and the button name button1 in an attribute edit region;
selecting type icon “event” in the graphical operation interface (i.e., generating a second selection instruction) and inputting the event name event1;
selecting “event1” from a binding component select list on the parameter configuration interface;
selecting button1 from a space attribute list on the parameter configuration interface;
editing a binding expression on the parameter configuration interface, configuring event event1, and establishing association between event1 and button1; and clicking “complete binding” to bind event1 to the page and generate the configuration data packet.

The specific steps of the method are described below.

Step S101 specifically includes: determining, according to a start position of a first selection instruction on the graphical operation interface, a control icon corresponding to the target function to be a text box button named button1.

Step S102 specifically includes: controlling, when a position of the first selection instruction on the graphical operation interface is ended in a preset region (i.e., the edit region), a display panel to display the control icon (i.e., button1) in the preset region.

Step S103 specifically includes: determining, according to a start position of a second selection instruction on the graphical operation interface, a type icon corresponding to the target function to be “event”, acquiring initial data of the “event”, and generating a corresponding function add instruction (step S110).

Step S104 specifically includes: controlling the display panel to display a parameter configuration interface associated with the target function.

Step S105 specifically includes: establishing an association relationship between button button1 and the target function corresponding to the initial data of “event type”.

The configuration parameters input by the user on the parameter configuration interface include: an event type being data source, an attribute key value param being text, and an attribute expression being @{WIDGET(button1.text)}. Step S120 specifically includes generating corresponding preliminary data according to the configuration parameters input by the user.

Step S200 specifically includes: generating a configuration data packet from the preliminary data obtained in step S120.

Embodiment 2, establishing a configuration data packet including preliminary data of interface type, where N=1 in step S110.

In this implementation, the interface is named as interface1, and the user needs to select a type icon corresponding to the “interface” on the graphical operation interface through a second selection instruction.

The steps performed by the user include:
selecting type icon “interface” in the graphical operation interface (i.e., generating the second selection instruction) and inputting interface name interface1; selecting “interface1” in a binding component select list of a parameter configuration interface;
editing a binding expression on the parameter configuration interface, and configuring the interface interface1, and clicking “complete binding” to bind the interface to the page and generate the configuration data packet.

Step S103 specifically includes: determining, according to a start position of a second selection instruction on the graphical operation interface, a type icon corresponding to the target function to be “cloud interface”, acquiring initial data of the “cloud interface”, and generating a corresponding function add instruction (step S110).

Step S120 specifically includes: determining, according to configuration parameters input by a user, a request mode corresponding to the cloud interface to be “get”, and determining, according to a url incoming format input by the user being http://xxx.xxx.xxx.xxx:port/apipath?city=xxx, a url of the cloud interface to be http://xxx.xxx.xxx.xxx:port, and configuring the initial data according to the above parameters, a path “apipath” and a key value “city” to obtain the preliminary data.

At step S200, a configuration data packet corresponding to the preliminary data of the cloud interface is generated.

Embodiment 3, generating a flow including three nodes, where N=3. The flow may implement the function of “clicking a button to display weather of the city”.

Firstly, a user may determine after analysis that the function of “clicking a button to display weather of the city” may be implemented by: clicking button button1 to implement flow flow1, which includes nodes node1, node2 and node3. Among others, node node1 shows a city name (e.g., city a) on the button, node node2 requests a weather service from the cloud interface and returns the result, and node node3 changes display content on button1 to the result returned from node2.

In this embodiment 3, step S100 needs to be performed three times at nodes node1, node2, and node3, respectively.

At node1, step S100 includes steps S101 to S105 and S120.

Step S101 specifically includes: determining, according to a start position of a first selection instruction on the graphical operation interface, a control icon corresponding to the target function to be a button named as button1.

Step S102 specifically includes: controlling, when a position of the first selection instruction on the graphical operation interface is ended in a preset region (i.e., the edit region), a display panel to display the control icon (i.e., button1) in the preset region.

Step S103 specifically includes: determining, according to a start position of a second selection instruction on the graphical operation interface, a type icon corresponding to the target function to be “event”, acquiring initial data of the “event”, and generating a corresponding function add instruction (step S110).

Step S104 specifically includes: controlling the display panel to display a parameter configuration interface associated with the target function.

Step S105 specifically includes: establishing an association relationship between button button1 and the target function corresponding to the initial data of “event type”.

The configuration parameters input by the user on the parameter configuration interface include: an event type being data source, an attribute key value param being text, and an attribute expression being @{WIDGET(button1.text)}. Step S120 specifically includes generating corresponding preliminary data according to the configuration parameters input by the user.

At node2, step S100 includes steps S103 to S104 and S120.

At step S103, determining, according to a position of the second selection instruction, a type icon to be “interface type”, and determining initial data corresponding to the type icon (i.e., performing step S110).

At step S104, controlling the display panel to display the parameter configuration interface.

The parameter configuration interface includes a key list of header parameters, and the user selects a specific header parameter according to the key list. In this implementation, the header parameter is city, and accordingly, the attribute expression is @{event(param)}. Therefore, an attribute value of key value of the event corresponding to node node1 may be assigned to a key value of the header parameter configured at the interface.

Step S120 specifically includes: configuring the initial data of node node2 with a service address corresponding to the interface input by the user and the attribute expression of @{event(param)} to obtain the preliminary data of node node2.

At node3, step S100 includes steps S103 to S104 and S120.

Step S103 specifically includes: determining, according to a start position of a second selection instruction on the graphical operation interface, a type icon corresponding to the target function to be “event”, acquiring initial data of the “event”, and generating a corresponding function add instruction (step S110).

Step S104 specifically includes: controlling the display panel to display a parameter configuration interface associated with the target function.

The configuration parameters input by the user on the parameter configuration interface include: an event type being data source, an attribute key value param being result, and the attribute expression may not be input. Step S120 specifically includes generating corresponding preliminary data according to the configuration parameters input by the user.

Step S200 is described below:

Firstly, at step S210, flow data is established, where i takes 1 and 2, respectively. Accordingly, step S110 includes:
determining, in response to a 1st node add instruction (i.e., a node add instruction for node node1), a 1st set of preliminary data as the preliminary data of “event type” generated for node node1 as described above; and determining, in response to a 2nd node add instruction (i.e., a node add instruction for node node2), a 2nd set of preliminary data as the preliminary data of “interface type” generated for node node2 as described above, and determining, according to the input information, a trigger expression of the 2nd node, and generating node data of the 2nd node from the 2nd set of preliminary data and the trigger expression. At step S213, the node data of the 1st node is processes by using index information of the node data of the 2nd node, so that the node data of the 1st node carries index information of the 2nd set of preliminary data. Since the 1st node (node node1) and the 2nd node (node node2) are interrelated, the attribute value (city) of the 1st node is assigned to the header parameter of the 2nd node in step S212.

Step S110 further includes: determining, in response to a 3rd node add instruction (i.e., a node add instruction of node node3), a 3rd set of preliminary data as the preliminary data of “event type” generated for node node3 as described above. The 3rd node and the 2nd node are interrelated. Since the attribute key value of the preliminary data of “event type” generated for node node3 is “result”, a return value of the interface corresponding to the 2nd node can be obtained. For example, the interface returns a value “json”, assuming {“result”:“ok”,“data”: {“temp”:“25° C.”,“pm2.5”:“100”,“desc”:“sunny” }}, the edit conversion expression may be written as @{RESPONSE(data,temp)}+@{RESPONSE(data,desc)}. In this case, the key value “result” of the 3rd node will be assigned with an attribute value of 25° C. sunny, and then the 3rd node is triggered (i.e., the temperature returned from the interface is displayed), and the flow is ended.

As described above, the configuration data is for generating an installation file of an application. In the present disclosure, the configuration data may be parsed with a compiling engine, and an installation file of the application may be generated according to the parsed result.

Accordingly, as a second aspect of the present disclosure, there is provided a method for generating an installation file of an application. As shown in FIG. 8, the method includes the following steps S310 to S320.

At step S310, a configuration data packet generated by the method according to the first aspect of the present disclosure is received.

At step S320, the configuration data packet is parsed and compiled to generate the installation file of the application.

With the above method, the installation file of an application can be constructed according to the configuration information, which is equivalent to providing a compiling environment. The method may be performed by the device for implementing the above method or by a server, and the method may be performed without information input by an operator. Therefore, even if an operator is not familiar with the compiling environment or the compiling language, it is still possible to generate the configuration data packet through the method in the first aspect of the present disclosure and finally obtain the file of the application.

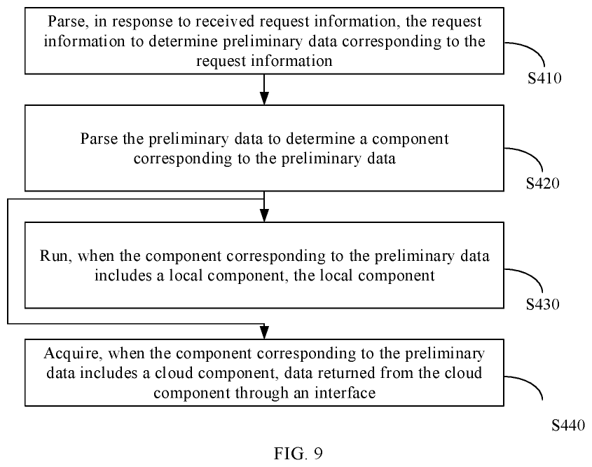

As a third aspect of the present disclosure, there is provided a method for processing request information. As shown in FIG. 9, the method for processing request information includes the following steps S410 to S440.

At step S410, in response to received request information, the request information is parsed to determine preliminary data corresponding to the request information. The preliminary data is one of local preliminary data and cloud preliminary data, the local preliminary data is obtained by performing parameter configuration on initial data of a local component capable of implementing the target function corresponding to the function add instruction, and the cloud preliminary data is obtained by performing parameter configuration on cloud information capable of implementing the target function corresponding to the function add instruction.

At step S420, the preliminary data is parsed to determine a component corresponding to the preliminary data.

At step S430, when the component corresponding to the preliminary data includes a local component, the local component is run.

At step S440, when the component corresponding to the preliminary data includes a cloud component, data returned from the cloud component is obtained through an interface.

The method for processing request information according to the present disclosure is a running process of the application constructed by the method according to the second aspect of the present disclosure. By processing the request information, the component to be operated can be determined, and finally the target function is implemented.

For the application constructed from the configuration data packet obtained in the above embodiment 3, the method for processing request information includes: analyzing, upon receipt of the request information, the preliminary data corresponding to the request information; and determining, through the preliminary data, that the preliminary data includes a flow configured on a page, triggering, when the flow is ended, a response event event2 that is configured on the page in advance. The event may be distributed through an event bus. If the page subscribes to the event, response processing is made in such a way that a binding expression and an associated control of data binding of the page for the event are obtained. Since button1 is associated, an attribute text of button1 is updated and thus the key value of event2 is set to the attribute value of “result” through a registered provider1, the “text” field of which “25° C. sunny” has been then assigned to. Notifying of provider1 is performed after the setting, and updating the display content of button1 is updated to “25° C. sunny”.

As a fourth aspect of the present disclosure, there is provided an electronic device, including:
one or more processors;
a storage device having stored thereon an executable program which, when executed by the one or more processors, causes the one or more processors to implement any one of the methods according to the above three aspects of the present disclosure.

As a fifth aspect of the present disclosure, there is provided a computer-readable storage medium having a computer program stored thereon which, when executed by a processor, implements any one of the methods according to the above three aspects of the present disclosure.

Those of ordinary skill in the art will appreciate that all or some operations of the above-described method, functional modules/units in the system and apparatus may be implemented as software, firmware, hardware, or suitable combinations thereof. In a hardware implementation, the division between the functional modules/units mentioned in the above description does not necessarily correspond to the division of physical components; for example, one physical component may have multiple functions, or one function or operation may be performed cooperatively by several physical components.

Some or all physical components may be implemented as software executed by a processor, such as a CPU, a digital signal processor or microprocessor, or implemented as hardware, or implemented as an integrated circuit, such as an application specific integrated circuit. Such software may be distributed on a computer-readable medium which may include a computer storage medium (or non-transitory medium) and a communication medium (or transitory medium). As is well known to those of ordinary skill in the art, the term computer storage medium includes volatile and nonvolatile, removable and non-removable medium implemented in any method or technology for storing information, such as computer readable instructions, data structures, program modules or other data. A computer storage medium includes, but is not limited to, RAM, ROM, EEPROM, flash memory or other memory technology, CD-ROM, digital versatile disc (DVD) or other optical disc storage, magnetic cartridge, magnetic tape, magnetic disk storage or other magnetic storage devices, or may be any other medium used for storing the desired information and accessible by a computer. Moreover, it is well known to one of ordinary skill in the art that a communication medium typically includes computer-readable instruction, data structure, program module, or other data in a modulated data signal, such as a carrier wave or other transport mechanism, and may include any information delivery medium.

It will be appreciated that the above implementations are merely exemplary implementations for the purpose of illustrating the principle of the present disclosure, and the present disclosure is not limited thereto. It will be apparent to one of ordinary skill in the art that various modifications and variations can be made to the present disclosure without departing from the spirit and essence of the present disclosure. These modifications and variations should also be considered as falling into the protection scope of the present disclosure.

1. A method for generating a configuration data packet of an application, comprising steps of: executing an instruction for generating preliminary data N times, and generating the configuration data packet according to the generated preliminary data, where N is a positive integer, and N≥1,
wherein each time of executing the instruction for generating preliminary data comprises:
determining, in response to a function add instruction, initial data of a target function corresponding to the function add instruction; and
performing parameter configuration on the initial data to obtain the preliminary data, wherein for any function add instruction, the preliminary data is one of local preliminary data and cloud preliminary data, the local preliminary data is obtained by performing parameter configuration on initial data of a local component capable of implementing the target function corresponding to the function add instruction, and the cloud preliminary data is obtained by performing parameter configuration on cloud information capable of implementing the target function corresponding to the function add instruction.

2. The method according to claim 1, wherein
in a case that N>1, the application comprises a flow having A nodes respectively corresponding to A target functions, and 1<A<N, the step of generating the configuration data packet according to the generated preliminary data comprises:
generating flow data from preliminary data for implementing the A target functions; and
generating the configuration data packet from the flow data and (N-A) sets of preliminary data corresponding to target functions not comprised in the flow;
in a case that N>1, the application comprises a flow having A nodes respectively corresponding to A target functions, and A=N, the step of generating the configuration data packet according to the generated preliminary data comprises:
generating flow data from A sets of preliminary data for implementing A target functions; and
generating the configuration data packet from the flow data.

3. The method according to claim 2, wherein generating flow data from A sets of preliminary data for implementing A target functions comprises:
determining an i^{th} set of preliminary data in response to an i^{th} node add instruction, and processing the i^{th} set of preliminary data to obtain node data of an i^{th} node, wherein the i^{th} set of preliminary data comprises preliminary data corresponding to a target function corresponding to the i^{th} node add instruction, so that the i^{th} node implements the target function corresponding to the i^{th} node add instruction, where i is a positive integer, and takes a value from 1 to (A−1) in sequence;
determining a (i+1)^{th} set of preliminary data in response to a (i+1)^{th} node add instruction, and processing the (i+1)^{th} set of preliminary data to obtain node data of a (i+1)^{th} node, wherein the (i+1)^{th} set of preliminary data comprises preliminary data corresponding to a target function corresponding to the (i+1)^{th} node add instruction, and a trigger expression of the (i+1)^{th} node, and the (i+1)^{th} node implements the target function corresponding to the (i+1)^{th} node add instruction;
processing the node data of the i^{th} node by using index information of the node data of the (i+1)^{th} node, so that the node data of the i^{th} node carries index information of the (i+1)^{th} set of preliminary data; and
generating the flow data from the first (A−1) sets of preliminary data each carrying index information and a trigger expression, and the A^{th} set of preliminary data not carrying index information.

4. The method according to claim 3, wherein the flow comprises at least one pair of interrelated nodes, initial data corresponding to interrelated nodes in a same pair comprises initial associated data, and for the interrelated nodes in the same pair, processing the preliminary data corresponding to a node later in sequence in the flow to obtain node data of the node comprises:
converting final associated data in a node earlier in sequence in the flow to obtain associated configuration parameters; and
configuring initial associated data in the preliminary data of the node later in sequence in the flow by using the associated configuration parameters.

5. The method according to claim 1, wherein each time of generating the preliminary data further comprises, before determining, in response to the function add instruction, initial data of the target function corresponding to the function add instruction:
determining, according to a start position of a second selection instruction on an operation interface, a type icon corresponding to the target function, and generating a function add instruction corresponding to the type icon, wherein there is a correspondence relationship between the type icon and the initial data.

6. The method according to claim 5, wherein each time of generating the preliminary data further comprises, before determining, in response to the function add instruction, initial data of the target function corresponding to the function add instruction, and after determining, according to the start position of the second selection instruction on the operation interface, the type icon corresponding to the target function, and generating the function add instruction corresponding to the type icon:
controlling a display panel to display a parameter configuration interface associated with the target function; and
the step of determining, for any function add instruction, initial data of the target function corresponding to the function add instruction comprises:
taking initial data corresponding to the type icon as the initial data corresponding to the function add instruction, wherein configuration parameters corresponding to the target function are received through the parameter configuration interface.

7. The method according to claim 5, wherein for at least one function add instruction, each time of generating the preliminary data further comprises, before determining, according to the start position of the second selection instruction on the operation interface, the type icon corresponding to the target function, and generating the function add instruction corresponding to the type icon:
determining, according to a start position of a first selection instruction on the operation interface, a control icon corresponding to the target function; and
controlling, when a position of the first selection instruction on the operation interface is ended in a preset region, a display panel to display a control icon selected by the first selection instruction in the preset region; and
binding received display information with the control icon selected by the first selection instruction, so that the display information is displayed when the control icon is clicked; and
the method further comprises after determining, according to the start position of the second selection instruction on the operation interface, the type icon corresponding to the target function, and generating the function add instruction corresponding to the type icon:
establishing an association relationship between the control icon and the target function.

8. The method according to claim 1, wherein when the initial data is of event type, performing parameter configuration on the initial data of event type comprises:
receiving event configuration parameters input from outside, wherein the event configuration parameters comprise an event name and at least one of: an attribute key value of the initial data, an attribute expression of the initial data, trigger mode information and associated control information; and
acquiring preliminary data of the initial data of event type according to the event configuration parameters.

9. The method according to claim 1, wherein when the initial data is of cloud interface type, performing parameter configuration on the initial data of cloud interface type comprises:
receiving at least one of a URL, a path, request mode information, a URL parameter, a header parameter and a body parameter input from outside; and
when the initial data is of local interface type, performing parameter configuration on the initial data of local interface type comprises:
receiving information about a local service and a calling mode of the local service input from outside, wherein the information about the calling mode is any one of synchronous calling or asynchronous calling.

10. The method according to claim 9, wherein when the initial data is of cloud interface type or local interface type, after acquiring the preliminary data, the method further comprises:
testing a service corresponding to the initial data.

11. The method according to claim 1, wherein the step of generating the configuration data packet according to the generated preliminary data comprises:
deleting, in response to a function delete instruction, preliminary data corresponding to the function delete instruction from the N sets of preliminary data; and
generating the configuration data packet from the remaining preliminary data.

12. The method according to claim 1, further comprising, after generating the configuration data packet according to N sets of preliminary data:
parsing and running the configuration data packet in response to a preview instruction.

13. The method according to claim 1, further comprising:
storing the configuration data packet locally.

14. The method according to claim 1, further comprising:
sending the configuration data packet to a server side.

15. The method according to claim 1, wherein the cloud information comprises interface information of a cloud component, and performing parameter configuration on the cloud information comprises performing parameter configuration on the interface information; or
related information of the cloud component comprises a cloud retrieve data packet, and the method further comprises, before performing parameter configuration on the initial data:
performing format conversion on the cloud retrieve data packet to obtain initial data corresponding to the target function.

16. A method for generating an application file, comprising:
receiving a configuration data packet generated by the method according to claim 1; and
parsing and compiling the configuration data packet to generate the application file.

17. A method for processing request information, comprising:
parsing, in response to received request information, the request information to determine preliminary data corresponding to the request information, wherein the preliminary data is one of local preliminary data and cloud preliminary data, the local preliminary data is obtained by performing parameter configuration on initial data of a local component capable of implementing a target function corresponding to a function add instruction, and the cloud preliminary data is obtained by performing parameter configuration on cloud information capable of implementing the target function corresponding to the function add instruction;
parsing the preliminary data to determine a component corresponding to the preliminary data;
running, in a case that the component corresponding to the preliminary data comprises a local component, the local component; and
acquiring, in a case that the component corresponding to the preliminary data comprises a cloud component, data returned from the cloud component through an interface.

18. An electronic device, comprising:
one or more processors;
a storage device having stored thereon an executable program which, when executed by the one or more processors, causes the one or more processors to carry out the method according to claim 1.

19. A computer-readable storage medium having stored thereon a computer program which, when executed by a processor, causes the processor to carry out the method according to am claim 1.

20. An electronic device, comprising:
one or more processors;
a storage device having stored thereon an executable program which, when executed by the one or more processors, causes the one or more processors to carry out the method according to claim 17.
